(19) United States
(12) Patent Application Publication
(10) Pub. No.: US 2026/0218485 A1
(43) Pub. Date: Jul. 30, 2026

(54) OPERATOR GUIDANCE FUNCTIONS FOR REMOTE CONTROLLED DEMOLITION ROBOTS

(71) Applicant: HUSQVARNA AB, Huskvarna (SE)

(72) Inventor: Tommy OLSSON, Huskvarna (SE)

(21) Appl. No.: 19/458,865

(22) Filed: Jan. 25, 2026

(30) Foreign Application Priority Data
Jan. 27, 2025 (SE) 2550064-6

(51) Int. Cl. E02F 3/96; E02F 9/20; E02F 9/26

(52) U.S. Cl. CPC E02F 3/965; E02F 9/205; E02F 9/265

(57) ABSTRACT

Remote controlled construction equipment includes a control unit configured to receive control commands from a remote control device, a chassis with caterpillar tracks arranged to support the equipment on a ground surface, a tower rotatably supported on the chassis to rotate about an axis of rotation, and a tool arm supported on the tower. A tool having opposing jaw members arranged movable in a jaw plane relative to each other is attachable at a distal end of the tool arm. The opposing jaw members of the tool are rotatable about an extension axis of the tool by a rotation actuator. The tool and/or the distal end of the tool arm includes a rotary encoder configured to determine a current rotation angle of the jaw plane relative to the tool arm, and to send a signal indicative of the current rotation angle to the control unit.

### TECHNICAL FIELD

The present disclosure relates to hydraulically powered construction equipment such as remotely controlled demolition robots and the like. There is disclosed construction equipment with operator guidance functions that simplify use of tools with opposing jaw members, such as steel shears, concrete crushers, and grapple tools.

### BACKGROUND

Construction equipment, such as remote controlled demolition robots, may be difficult to use efficiently, in particular if the view of the work object to be engaged by the tool carried by the equipment is not clearly visible or located some distance away from the operator. The work object may be partly hidden by dust, and lighting at the work site may be poor.

Some remote controlled construction equipment is adapted to carry tools with opposing jaw members which must be properly aligned with the work object before the tool can be used, such as steel shears, concrete crushers, and grapple tools. These tools are particularly difficult to use in poor visibility conditions since they must be correctly rotated, sometime with high accuracy, relative to the work object, before they can engage the work object successfully.

There is a need for operator guidance functions, in particular guidance functions that simplify use of tools with opposing jaw members, such as such as steel shears, concrete crushers, and grapple tools.

There is also a need for a higher level of automation of repetitive work tasks such as demolition of some types of structures.

US 2018317397 A1 describes robotic tree pruning equipment. The equipment comprises a support structure such as a trailer or the like, and a jointed arm with a cutting tool arranged at its distal end.

### SUMMARY

It is an objective of the present disclosure to provide operator guidance functions that simplify and in some cases at least partly automate use of tools with opposing jaw members. This objective is at least in part obtained by remote controlled construction equipment comprising a control unit that is configured to receive control commands from a remote control device, a chassis with caterpillar tracks arranged to support the equipment on a ground surface, a tower that is rotatably supported on the chassis in order to rotate about an axis of rotation, and a tool arm that is supported on the tower. A tool that comprises opposing jaw members arranged movable in a jaw plane, relative to each other, is attachable at a distal end of the tool arm such that it can be supported by the tool arm and controlled by the operator via the remote control device. The opposing jaw members are rotatable about an extension axis of the tool by a rotation actuator which allows the tool to be correctly positioned in relation to a work object in order to engage the work object by the jaw members. The tool and/or the distal end of the tool arm, i.e., the tool interface on the tool arm, comprises a rotary encoder configured to determine a current rotation angle of the jaw plane relative to the tool arm. This rotary encoder is arranged to send a signal indicative of the current rotation angle to the control unit, which implements one or more automated actions based on the signal from the rotary encoder. This way the control unit 105 becomes aware of the current rotation angle of the tool, which means that several operator guidance functions are enabled. A display device on the remote control device can for instance be used to reliably communicate the current angle of rotation of the tool to the operator of the construction equipment, which allows the operator to control tool rotation even if the tool is not clearly visible to the operator. Several semi-automated or automated control functions can also be realized in a reliable manner, as will be described in more detail in the following. More reliable rotation angle data also results from the rotary encoder compared to other systems based on, e.g., a visual sensor such as a camera that is arranged to monitor the tool and provide feedback as a real time video stream. The accuracy of the data from the rotary encoder is, for instance, not dependent on visibility and light conditions at the work site, as is the case for a camera-based system.

Some of the tools discussed herein are tiltable about a pivot axis at the distal end of the tool arm by a tilt actuator in addition to being rotatable about the tool extension axis. The control unit can in this case also be arranged to determine a current tilt angle of the tool based on a state of the tilt actuator, such as the position of a hydraulic cylinder used to control tool tilt. The control unit can for instance be configured to obtain a desired relative orientation between the jaw plane of the tool and a reference plane defined by the control unit. The control unit can then automatically control the rotation actuator of the tool and/or the tilt actuator to align the rotation angle of the jaw plane and the tilt angle at the desired relative orientation. In other words, the control unit, having regard to the current tilt angle in combination with the current rotation angle of the jaw plane can control the different movable members on the construction equipment to reduce the difference between the current orientation the jaw plane of the tool and the desired orientation of the jaw plane in relation to the reference plane. The reference plane can, e.g., be a horizontal plane, which allows an operator to set a desired orientation of the jaw plane relative to the horizontal plane, which orientation will then be maintained as the operator controls the different movable parts of the construction equipment. For instance, suppose that the ground surface supporting the construction equipment is not even, and that the construction equipment is moved over the uneven surface during a work task. The control unit will then adjust the orientation of the tool to keep the jaw plane at the desired orientation relative to the horizontal plane as the construction equipment moves over the uneven surface, which simplifies control of the tool and the equipment.

The control unit may also be configured to obtain a desired relative pointing direction of the extension axis of the tool, and to control the tilt actuator and the rotation actuator to reduce a difference between a current pointing direction of the extension axis of the tool and the desired relative pointing direction of the extension axis of the tool. The tool will then maintain a given configured pointing direction as the operator maneuvers the equipment on the work site, which is an advantage. This function is advantageously combined with a tool interface at the distal end of the tool arm which comprises a tilt rotator, i.e., an actuator which allows an arbitrary pointing direction of the tool over some range to be configured.

In some cases the operator needs to rotate the tool over a large angle to bring the rotation angle of the tool close to the desired rotation angle. In such cases if may be convenient if the control unit is configured to control the rotation actuator to rotate the tool about the extension axis in discrete rotation steps. Each rotation step controlled by the operator then results in rotation by a predetermined or configurable number of degrees, such as in steps of five or ten degrees. According to some aspects, the control unit is configurable in a continuous rotation mode and a discrete step rotation mode, where the control unit is configured to control the rotation actuator to rotate continuously in response to a control command from the remote control device when in the continuous rotation mode, and to control the rotation actuator to rotate in discrete rotation steps when in the discrete step rotation mode. The operator can then select which mode of operation that is best for the work task at hand. Often the operator desires to first quickly rotate the tool to an angle close to the desired one, and then use the continuous rotation mode for fine-tuning the angle of rotation. According to a preferred embodiment, the tool rotation in the discrete step rotation mode has a faster angular rate of rotation compared to the continuous rotation mode.

According to other aspects of the teachings herein, the control unit is arranged to obtain a desired feed direction of the tool, such as a straight line feed direction. In this case the control unit can be configured to control any of the caterpillar tracks, the tower, the tool arm and/or the rotation actuator to move the tool along the feed direction in response to a control command from the remote control device. This way an operator can move the tool along a work object and engage the work object at regular intervals in a convenient manner. Any unevenness in a ground surface supporting the construction equipment can be compensated for by the control unit while moving the tool along the feed direction. The control unit can for instance be arranged to obtain the desired feed direction of the tool as a straight line fit to two or more past positions of the tool. The operator, desiring to define a feed direction, simply places the tool at two or more positions along the desired feed direction, and the control unit then determines the desired feed direction from fitting a straight line to the two or more positions. The control unit can of course also be arranged to obtain the desired feed direction of the tool based on manual input from an operator of the equipment, e.g., via the remote control device.

The remote controlled construction equipment may also comprise a vision-based sensor such as a camera that is arranged to monitor an area in front of the tool. The control unit can then be configured to detect a marker arranged on a work object having predetermined visual characteristics, and to control any of the caterpillar tracks, the tower, the tool arm and/or the rotation actuator to engage the work object at the marker. An operator or other person at the work site can then mark a given work object to be engaged by the tool at one or more locations, e.g., by colored paint or other types of marker. The construction equipment comprising the vision-based sensor can then be arranged to detect the markers and to automatically or semi-automatically engage the work object at the locations indicated by the markers.

The objective is also at least in part obtained by remote controlled construction equipment comprising an environment sensor configured to observe a work object in vicinity of the construction equipment, where the control unit is configured to receive data related to an extension direction of the work object from the environment sensor, and to trigger an automated guidance function involving rotation of the tool about the extension axis to position the opposing jaw members in relation to the work object. This way at least a part of the tool maneuvering is taken over by the control unit, which simplifies the work task. The time to complete a work task is reduced by automating a work task in this manner, which is an advantage. According to some aspects, the control unit is arranged to control the rotation actuator of the tool to rotate the tool to a position suitable for engaging the work object. The control unit can also be arranged to obtain data related to a distance between the tool and the work object, and to trigger the automated guidance function when the distance satisfies a rotation proximity acceptance criterion. This type of automation resembles a snap-in behavior where the tool performs one or more automated tasks as soon as the operator moves the tool close enough to a work object. The operator simply maneuvers the tool within range of a work object, and the tool will then automatically engage the work object. The distance to the work object that is required in order to satisfy the rotation proximity acceptance criterion is normally relatively small for safety reasons, such as on the order of tens of centimeters.

According to a preferred embodiment, the automated guidance function comprises an automated reduction of a movement speed of the tool when the distance to the work object satisfies a speed reduction acceptance criterion. The operator, having brough the tool “within reach” of the work object, i.e., within a distance that satisfies the speed reduction acceptance criterion experiences an increase is maneuvering accuracy due to the reduction in movement speed. This way an operator is able to more easily position the tool in relation to a work object.

According to some aspects, the automated guidance function comprises an automated positioning and/or alignment of the tool in relation to the work object when the distance satisfies a positioning acceptance criterion. This function also resembles a snap-in behavior function. As soon as the tool comes close enough to a work object, the control unit automatically positions the tool to engage the work object. The tool may for instance be a pipe that extends along an extension direction. An operator then only needs to bring the tool close enough to the pipe, i.e., within a distance which satisfies the positioning acceptance criterion in order for the tool to be automatically rotated and possibly also automatically tilted to engage the pipe in order to, e.g., cut the pipe or grasp the pipe by the jaw members of the tool.

The control unit is optionally arranged to detect when the opposing jaw members of the tool are correctly positioned for engaging the work object, and to trigger an automated actuation of the jaw members as a result of detecting that the jaw members are correctly positioned. This saves some effort on behalf of the operator since the operator only needs to move the tool in position to engage the work object. Once in position the tool will automatically engage the work object, possibly in response to an acknowledgement input by the operator. The control unit can for instance be arranged to obtain data indicative of a position of the work object relative to the opposing jaw members from the environment sensor, and to detect when the opposing jaw members of the tool are correctly positioned when the position of the work object relative to the opposing jaw members satisfies a first jaw engagement acceptance criterion. According to another example the control unit is arranged to obtain data indicative of a hydraulic pressure in one or more hydraulic actuators of the tool arm, and to detect when the opposing jaw members of the tool are correctly positioned when the hydraulic pressure satisfies a second jaw engagement acceptance criterion.

According to some other aspects, the control unit is configured to abort the automated guidance function in case the operator releases the remote control device and/or discontinues manipulation of the remote control device. This is mainly a safety-related function of the construction equipment. Should the operator for some reason let go of the remote control device or stop inputting commands, then movement by the construction equipment will cease in order to prevent unintended and/or unmonitored movement by the equipment.

The objective is furthermore at least in part obtained by remote controlled construction equipment comprising a control unit that is arranged to trigger an automated disengagement routine following engagement between the jaws of the tool and the work object. The disengagement routine comprises moving the opposing jaws away from each other followed by moving the tool away from the work object. The operator, having engaged a work object, is then spared the extra maneuvering commands necessary to disengage from the work object before the tool can be moved to a new engagement location on the work object or on some other work object, which is an advantage.

The construction equipment may comprise a display device arranged to display an image of a potential work object, e.g., to an operator of the equipment via a display on the remote control device. The control unit can also be arranged to obtain confirmation from an operator indicating that the potential work object is a work object to be engaged by the tool. This may be a prerequisite for triggering one or more of the automated actions described herein. The confirmation is a safety-related improvement of the construction equipment which greatly reduces the risk of engaging an object that is not a work object intended to be engaged by the tool.

There are also disclosed herein processing circuits, computer programs, computer program products as well as methods associated with the advantages mentioned above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example remote controlled demolition robot;

FIGS. 2A-C show example tools for use with a demolition robot;

FIG. 3 illustrates an example portable remote control device;

FIGS. 4A-B shows an example of steel shears engaging a work object;

FIG. 5 schematically illustrates a computer implemented pose model;

FIG. 6A illustrates jaw plane alignment relative to a reference plane;

FIG. 6B shows configuration of a tool pointing direction;

FIG. 7 illustrates a work task involving a tool engaging a work object;

FIGS. 8A-B are flow charts illustrating methods;

FIG. 9 schematically illustrates a control unit; and

FIG. 10 schematically illustrates a computer program product.

### DETAILED DESCRIPTION

The invention will now be described more fully hereinafter with reference to the accompanying drawings, in which certain aspects of the invention are shown. This invention may, however, be embodied in many different forms within the scope of the appended claims and should not be construed as limited to the embodiments and aspects set forth in this detailed description; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

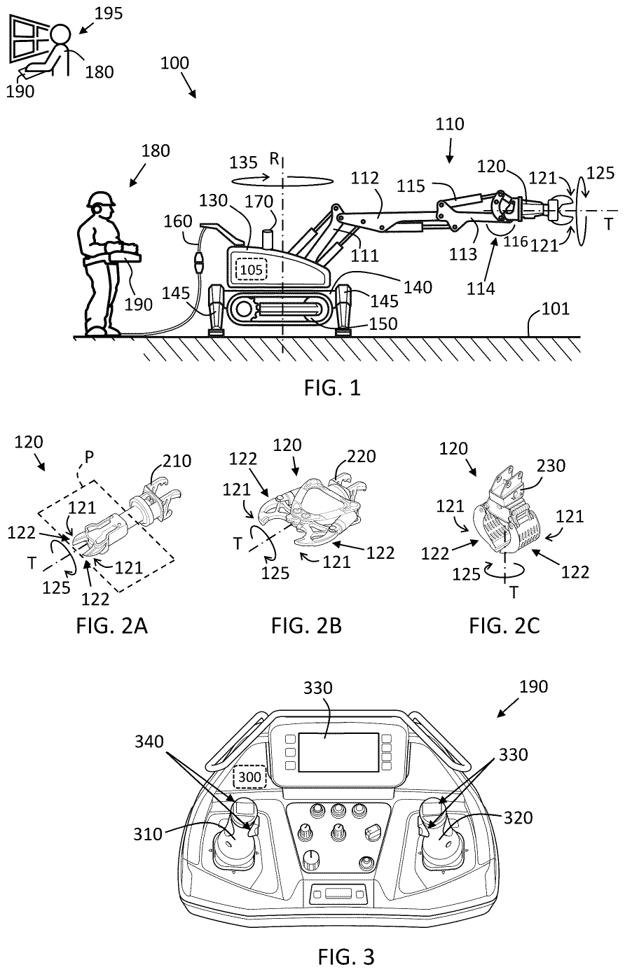

FIG. 1 illustrates a remote controlled demolition robot, which is an example of more general construction equipment 100 where the techniques discussed herein can be applied. The various technical features and functions disclosed herein will be exemplified by the remote controlled demolition robot. It is, however, appreciated that many aspects of the present disclosure are in no way limited to demolition robots, but can be applied generally in many types of construction equipment, such as excavators, wheel loaders, haulers, mobile cranes, and so on.

The construction equipment 100 comprises tracks 150 for maneuvering the robot over the ground surface 101. The bottom parts of the tracks 150 that are configured to engage the ground surface 101 define a support plane of the construction equipment 100. Both electrically powered tracks and hydraulically powered tracks can be used with the type of construction equipment 100 discussed herein. The tracks are supported on a chassis 140 of the construction equipment, which may comprise steel beams or the like welded into a rigid frame. The chassis 140 normally extends along a plane parallel to the support plane defined by the tracks 150.

A tower 130 or body is rotatably mounted on the chassis 140. The tower is arranged to rotate about a rotation axis R which is normal to the support plane defined by the tracks 150. The tower 130 can be rotated by a hydraulic or an electric actuator in response to a control signal from a control unit 105 onboard the construction equipment 100.

Outriggers 145 extend out from the chassis 140. The outriggers 145 support the chassis 140 on the ground surface 101 when deployed (as in FIG. 1) and offer an alternative or a complement to the ground support provided by the tracks 150. The outriggers 145 can be retracted from the ground surface to reduce the footprint of the machine, e.g., during transportation or when the additional support provided by the outriggers is not necessary. The example machine in FIG. 1 comprises four outriggers 145, two at each longitudinal end of the machine. At deployment, the outriggers pivot out from the chassis to engage the ground surface with respective distal ends. The outriggers, when deployed, can be used to define a support plane of the construction equipment. This support plane is then the plane which intersects the feet of the deployed outriggers.

An arm 110, sometimes referred to as a tool carrier, is supported by the tower 130 and extends out from the tower 130. The tool carrier arm 110 according to the example in FIG. 1 comprises three joints that connect three respective arm segments 111, 112, 113. Hydraulic cylinder actuators control the pivoting motion of the arm segments about the joints in a known manner. The position of these hydraulic cylinders has a one-to-one correspondence to the respective joint angle.

A fourth hydraulically actuated joint 114 is located at the distal end of the arm 110 where an interface for attachment of a replaceable tool 120 is located. The fourth arm joint is actuated by the hydraulic cylinder 115 in response to a tool tilt signal from the control unit 105. The hydraulic cylinder 115 at the distal end of the tool arm may be referred to as a tilt actuator since it can be used to tilt a tool attached at the distal end of the arm.

The four arm joints of the tool arm 110 allow a tool 120 attached to the distal end of the tool carrier arm 110 to be positioned with great dexterity. There can be less than four joints and also more than four joints on a tool arm. However, a tool carrier arm with four joints and three arm segments as illustrated in FIG. 1 has been found particularly suitable for remote controlled demolition robots.

The construction equipment 100 is normally powered by an onboard hydraulic system which comprises a hydraulic pump, valves, and actuators which control movement of the different members on the equipment 100, such as rotation of the tower 130 and movement of the tool carrier arm 110, in a known manner. The on-board control unit 105 controls the different operations of the equipment 100. The on-board control unit 105 communicates with the hydraulic pump and the hydraulic valves of the hydraulic system using electrical signals which may be analog or digital signals. The control unit 105 may use a controller area network (CAN) to communicate with the valves and with other devices onboard the construction equipment 100.

The construction equipment 100 is powered by an electrical interface 160 as exemplified in FIG. 1. This electrical interface is arranged to be connected to electrical mains or to some other source of electrical power at the work site, such as a genset or an external battery pack. The construction equipment 100 may also comprise an onboard battery pack to complement the external power supply. Such demolition robots are generally known as hybrid demolition robots.

The construction equipment 100 can be remote controlled from a portable remote control device 190 which can be used by an operator 180 walking next to the equipment. The remote control device 190 sends control signals to the onboard control unit 105 via a wired or a wireless communication channel, which then controls the different actuators of the construction equipment 100 accordingly. The operator 180 may also be located further away from the machine, such as in a remote control room 195 several kilometers away, in which case a video feed, possibly complemented by an audio feed, can be used to control the various actuators on the equipment 100.

Various types of tools 120 can be mounted at the distal end of the arm 110. FIGS. 2A-C show steel shears 210, a concrete crusher 220, and a grapple 230, which are all examples of tools that can be carried by the arm 110. The tools 120 in FIGS. 2A-C all comprise opposing jaw members 122 which extend out from pivot points at the distal end of the tool arm 110 such that they can swing against each other in a jaw plane P (only indicated in FIG. 2A). The pivot axes of the jaw members are normal to the jaw plane P. As the opposing jaw members move against each other, a work object received inbetween the jaws will be engaged by the jaws and cut, crushed, or held, by the steel shears 210, the concrete crusher 220 or the grapple 230, respectively.

The opposing jaw members 122 of the tool 120, 210, 220, 230 are rotatable 125 about an extension axis T of the tool, which means that the jaw plane P rotates about the extension axis T of the tool as exemplified in FIG. 2A. The extension axis T extends out from the tool interface at the distal end of the tool arm 110, as shown in FIG. 1. The tool extension axis T can be tilted at a tilt angle 116 relative to the last tool arm segment 113 by the corresponding hydraulic actuator 115 on the tool arm 110. By tilting and rotating the tool 120, the jaw plane P can be suitably positioned for engaging a work object by the opposing jaw members. Position sensors such as linear transducers and rotary encoders are preferably arranged in connection to the tool 120 to measure the current angle of the jaw plane P with respect to, e.g., the support plane of the construction equipment. The position sensors can be configured to transmit data indicative of the current rotation and/or tilt angle of the tool 120 to the control unit 105, which then obtains information about the current orientation of the tool 120.

The tool may comprise a rotation actuator such as an electric or a hydraulic rotation actuator arranged to rotate the tool about the extension axis T. Rotation of the tool 120 by a rotation actuator occurs in response to a control signal from the onboard control unit 105, which may be generated by the control unit 105 in an automated manner and/or based on an instruction received from the remote control device 190, which in turn may be generated by manual manipulation of, e.g., a thumb switch or the like.

Some tools may only comprise a rotary joint and no rotation actuator. In this case an external force must be applied to the tool in order to rotate the tool about the extension axis T. This can be done manually by the operator at the work site, or by bringing the tool 120 into contact with some fixed object such as a wall or the like to force a rotation of the tool.

A tilt rotator can be arranged at the distal end of the tool arm 110 to further increase the dexterity of the tool. A tilt rotator allows repositioning of the tilt axis of the tool in a known manner. Tilt rotator tool interfaces are generally known and will therefore not be discussed in more detail herein.

The chassis 140 can be used as reference for the position of the different parts on the construction equipment 100. A forward direction of the construction equipment can be defined as a direction which extends longitudinally along a center line of the chassis. This direction remains fixed as the tower rotates but will change if the tracks 150 are used to rotate the construction equipment relative to the ground surface 101. The support plane defined by the bottom parts of the tracks 150 or the support plane defined by the outriggers 145 when deployed can be used as used as reference for the position of the different parts on the construction equipment 100. The position of any movable member of the construction equipment 100 can be defined in relation to this type of support plane and forward direction.

The control unit 105 may also comprise an electronic spirit level, such as an inertial measurement unit (IMU) configured to determine an angle of the support plane relative to the horizontal plane or some other global reference plane. This allows the control unit to determine the angle of the jaw plane P relative to the global reference plane. Consequently, the control unit 105 may also be configured to automatically position the jaw plane at a desired angle relative to a global reference plane, such as a horizontal plane.

A computer implemented pose model 500 will be discussed below. The control unit 105 can use this pose model 500 to determine a current pose of the tool 120, and also to control actuators of the construction equipment 100 in order to bring the tool 120 into a desired pose.

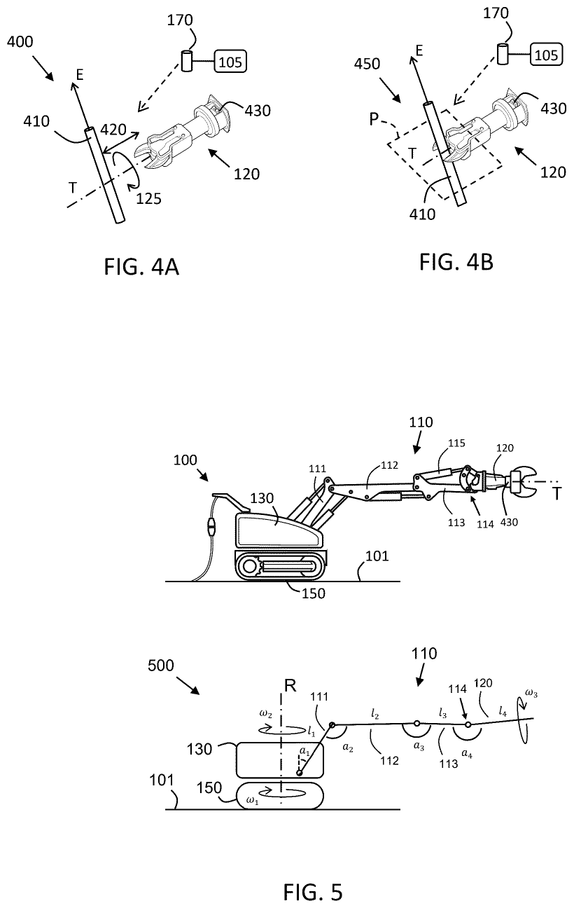

The extension direction of the work object, such as the extension direction of a pipe, a beam, or a straight piece of rebar, should preferably be normal to the jaw plane P, in which case the work object can be received in the gap formed inbetween the opposing jaw members 122. A rebar or pipe can enter between the jaws of the steel shears 210 and be cut as the jaws move against each other to engage the rebar or pipe. A piece of concrete, such as a part of a wall or a concrete beam can be positioned between the jaws of a concrete crusher 220 and be crushed between the jaws as the jaws move against each other. The jaws of the grapple 230 can be used to hold an elongated object having the extension direction as long as this elongated object is correctly positioned in relation to the opposing jaws of the grapple. An example work task involving steel shears engaging a pipe will be discussed in more detail below in connection to FIGS. 4A-B.

It may be difficult to position a tool such as the steel shears 210, the concrete crusher 220 or the grapple 230 with respect to a work object such as a rebar, a pipe, a piece of concrete or some other elongated object. A purpose of the present disclosure is to provide various operator guidance functions which assist an operator 180 by automatically rotating the tool about the tool extension axis T into position for receiving a work object inbetween the opposing jaw members.

FIG. 3 shows an example remote control device 190. The device may be a portable device which the operator 180 can carry while moving around the work site or a device designed to be used as a remote control station 195 located far away from the construction equipment 100. This example remote control device 190 comprises a remote control device control unit 300, two joysticks 310, 320, and a display unit 330. The operator 180 manipulates the two joysticks 310, 320 in a known manner which causes the remote control device control unit 300 to send control commands to the onboard control unit 105, which in turn controls the different actuators on the construction equipment 100, such as rotation of the tower 130 and the different actuators on the tool arm 110. The opposing jaw members 122 on steel shears, a concrete crusher or the grapple may, e.g., be controlled using one of the thumb control switches 330, 340. One thumb control switch can, for instance, be used to open and close opposing jaw members 122 of a tool such as the steel shears 210, the concrete crusher 220 and the grapple 230 discussed above in connection to FIGS. 2A-C. Another thumb control switch can be used to rotate the tool about the tool extension axis T in a clockwise or a counter-clockwise direction.

The display unit 330 can be used to display information to the operator, and also to obtain instructions and commands from the operator. The remote control device 190 can, for instance, display an image of a potential work object in front of the tool by the display 330, and the operator can indicate or acknowledge that a given object on the display is a work object to be engaged by the tool 120. The on-board control unit 105 may then proceed to automatically adjust the tool in terms of rotation angle about the extension axis T as part of an automated guidance function, and potentially also proceed with an automated engagement of the acknowledged work object.

The construction equipment 100 optionally comprises one or more environment sensors 170, which are sensors used to monitor the environment surrounding the equipment. An environment sensor 170 may comprise any of a camera, a radar, a lidar, and/or an ultrasound sensor. The environment sensor is according to some aspects arranged to observe a work object to be engaged by the tool 120 in order to determine a suitable rotation angle of the tool for engaging the work object. The environment sensor 170 feeds detection data to the control unit 105 which allows the control unit 105 to determine, e.g., an extension direction of the work object and a position of the work object in relation to the tool 120 on the distal end of the tool arm 110. The environment sensor data fed back from the environment sensor 170 to the control unit 105 may also be forwarded, possibly after some processing of the data, to the remote control device 190. In this case the remote control device 190 may be configured to display, e.g., a real time video feed or a radar detection point cloud on the display device 330 of the remote control device 190.

Computer implemented methods for identifying objects in a camera feed, a radar signal, or a lidar signal are generally known and will therefore not be discussed in more detail herein. The control unit 105 and/or the remote control device 190, having access to the data from the environment sensor 170, either as raw data or as processed data, may obtain information about objects in vicinity of the tool 120, such as a pipe, beam or concrete structure to be engaged by the tool by the opposing jaw members. Of particular importance is the extension direction of the work object since the extension direction must be properly aligned with the jaw plane in order for the opposing jaw member to be able to engage the work object successfully. Functions for automatically feeding the tool along the extension direction of a work object will also be discussed below.

The control unit 105, having access to the extension direction of the work object in relation to the tool 120, can be configured to rotate the tool to a suitable rotation angle for engaging the work object as part of an automated guidance function of the construction equipment 100. According to some aspects the control unit 105 also control tilt of the tool to align the opposing jaw members with the work object. It is appreciated that by tilting and rotating the jaw plane P, a suitable alignment between the opposing jaw members and a work object having an extension direction, can normally be found by the control unit 105.

FIGS. 4A-B illustrate an example of how this type of automated guidance function may operate in practice. In FIG. 4A the operator has brought the tool 120 (in this case steel shears) in vicinity of a work object 410 to be engaged by the tool 120. In this case the work object is a section of pipe that is to be cut by the steel shears. To cut the pipe the steel shears must first be rotated 125 to the correct engagement angle. The operator, having brough the tool 120 to a distance 420 from the work object 410 activates the automated guidance function. The control unit 105 then obtains data from the environment sensor 170 about the geometry of the work object 410 in relation to the position and orientation of the tool 120. This data may, e.g., comprise an indication of the extension direction E of the work object 410 and possibly also the position of the work object in relation to the tool 120. The control unit 105, having regard to the extension direction of the work object 410 then sends a control signal to the rotation actuator 430 of the tool in order to rotate the tool into a rotation angle suitable for engaging the work object 410. A suitable rotation angle of the tool 120 is, generally, such that the extension direction of the work object is approximately normal to the extension jaw plane P of the opposing jaw members. A suitable position of the tool in relation to a work object is such that the extension axis T of the tool intersects the work object, and such that the work object is received in the gap between the opposing jaw members. Thus, the extension axis T can be seen as a form of boresight line to be aimed at the work object. A tool to be brought into engagement with a work object can first be positioned such that the extension axis T intersects the work object, as shown in FIG. 4A, and then moved in direction of the extension axis T until the work object has been properly received in the gap formed between the opposing jaw members, as shown in FIG. 4B. After rotating the tool to the correct rotation angle, and properly positioning the tool in relation to the work object, as shown in FIG. 4B, the work object can be engaged.

Many of the guidance functions described herein rely on accurate information about the current pose of the tool in relation to the tool interface, and in some cases also the pose of the tool in relation to, e.g., the support plane and forward direction of the construction equipment as discussed above. A camera-based system can of course be directed at the tool and the video stream can be fed back to the operator in order to allow the operator to discern the current rotation angle of the tool, e.g., relative to a work object to be engaged. However, camera-based systems may not be effective in poor visibility conditions, or if there is a lot of dust on the workplace that covers the camera lens. Aspects of the present disclosure therefore relate to remote controlled construction equipment 100 that comprises a tool 120, 210, 220, 230 with opposing jaw members 122 arranged movable 121 in a jaw plane P relative to each other. The tool is attached at the distal end of the tool arm 110 of the equipment 100, e.g., as shown in FIG. 1. The opposing jaw members 122 of the tool 120, 210, 220, 230 are rotatable 125 about an extension axis T of the tool by a rotation actuator 430, such as a hydraulic motor or an electric actuator that is controlled by the control unit 105, often based on control commands received from the remote control device 190. In order for the control unit 105 and/or the remote control device 190 to obtain information about the current rotation angle of the tool, the tool 120, 210, 220, 230 and/or the tool interface at the distal end of the tool arm comprises a rotary encoder configured to determine a current rotation angle of the jaw plane P relative to the tool arm 110, and to send a signal indicative of the current rotation angle to the control unit 105. The control unit 105 can then translate the data received from the rotary encoder into the pose data necessary to implement one or more of the different tool guidance functions described herein, or just display the current angle of rotation of the tool on a display device of the construction equipment, such as the display 330 on the remote control device.

The rotary encoder may be arranged to report an absolute rotation angle or to report a change in rotation angle. In case of a rotary encoder configured to report change in rotation angle, a calibration procedure may be required to allow the control unit to translate change in rotation angle into absolute rotation angle. According to some aspects the control unit 105 is configured to rotate the tool to a given predetermined rotation angle in order to calibrate the rotation angle sensor. The predetermined rotation angle can be a rotation angle end stop or the position of a sensor such as a Hall effect sensor arranged to detect when the tool is rotated to a predetermined rotation angle.

According to some aspects, the tool 120, 210, 220, 230 comprises a rotary encoder configured to determine the current rotation angle of the jaw plane P relative to the tool arm 110 as a detection of at least one discrete rotation angles, and to send a signal indicative of the current rotation angle to the control unit 105 as a detection indicating that the tool is at the discrete rotation angle. In this case the rotary encoder only comprises one or more detectors which detect when the tool is at a given rotation angle, such as a Hall effect sensor or a mechanical switch. The control unit 105 can then rotate the tool to the predetermined angle in order to zero the rotation determination system, and then determine the current rotation angle by integrating rotation commands. The control unit may be configured to periodically recalibrate the rotary encoder system by rotating the tool to the predetermined angle and zero the rotation integration parameter used to keep track of the current rotation parameter.

The tool 120, 210, 220, 230 can also be tiltable about a pivot axis 114 at the distal end of the tool arm 110 by a tilt actuator 115, such as a pivot axis that extends in a direction parallel to the extension plane of the chassis and parallel to the support plane defined by the bottom parts of the tracks 150. The pivot axis 114 may also be referred to as a tool tilt axis. The control unit 105, having access to the state of the tilt actuator 115, can determine a current tilt angle a₄ of the tool. The control unit 105 can perform this determination of tilt angle using, e.g., a straightforward look-up table that relates tilt actuator state to tilt angle. A mathematical function implemented at the control unit can also be used to relate tilt actuator state to tilt angle. The position of a hydraulic cylinder, as illustrated in FIG. 1, can for instance be translated into tilt angle.

FIG. 5 schematically illustrates how an example computer implemented model 500 of machine pose can be realized. This pose model can be used to determine a current position and orientation of the tool 120, and also to maneuver the tool 120 into a suitable position and orientation for engaging a work object. The model is parameterized by the geometry of the different parts on the construction equipment, such as the dimensions of the tracks 150, the shape and size of the tower 130, and the tool arm 110, which are all parameters that can be hard-coded since they are constant in use. Of particular interest are the different lengths l₁, l₂, l₃ of the different tool arm segments 111, 112, 113, and the length l₄ of the tool 120 attached to the distal end of the tool carrier arm 110. The pivot angles a₁, a₂, a₃ of the tool arm segments 111, 112, 113, and the pivot angle a₄ of the tool 120 are also important, as well as the rotation angle ω₂ of the tower 130

about the axis of rotation R, relative to the chassis and the tracks. The rotation angle ω₃ of the tool about the tool extension axis T is of course central.

The rotation angle of the chassis ω₁ relative to, e.g., magnetic north, can be used to align the positions of the parts on the construction equipment 100 in relation to some global reference system such as WGS-84. The control unit 105, having information about the current values of the different model parameters can determine the current pose of the construction equipment 100 and thus also the positions of the movable members and the other parts of the equipment 100, including the tool 120. It is appreciated that there is a one-to-one mapping between the state of a given hydraulic cylinder on the tool arm and the corresponding pivot angle.

The control unit 105 can use a computer implemented model 500 of machine pose to simulate different control commands in order to determine a suitable sequence of actuator commands which bring the tool to a desired position, and/or into a desired orientation or pose with respect to a work object or with respect to the chassis.

An IMU can be used to relate an angle of the support plane of the construction equipment to some global reference plane such as the horizontal plane. Thus, the control unit 105 can use the computer implemented pose model to relate the position and orientation of the jaw plane P of the tool 120 to, e.g., the horizontal plane. This is particularly advantageous if the construction equipment is supported on a ground surface 101 which is not level. It may be difficult or at least cumbersome and time consuming for an operator of the equipment 100 to compensate for unevenness in the ground surface 101 as the equipment moves over this surface. However, by relating the tool pose to a reference plane such as a horizontal plane and/or a vertical plane, the control unit 105 can automatically compensate for unevenness in the ground surface 101 as the equipment moves over the surface.

The environment sensor 170 can be used to determine the relative positions and orientations of the tool and a work object. The control unit 105, having regard to the relative positions of tool and work object, can then determine the necessary adjustment of tool position and orientation to position the tool suitably for engaging the work object. A suitable position of the tool in relation to the work object is illustrated in FIG. 4B, where the extension direction E of the work object 410 is approximately normal to the jaw plane P, and where the work object 410 is received in the gap formed between the opposing jaw members of the tool 120.

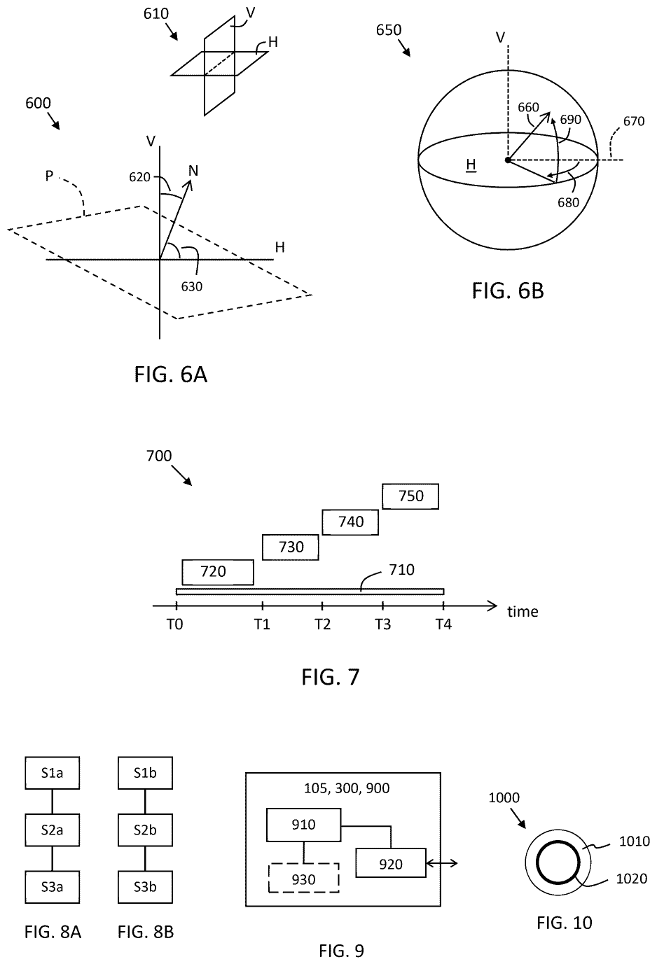

With reference to FIG. 6A, the control unit 105 can be configured to obtain a desired relative orientation 600 between the jaw plane P and a reference plane 610, such as the horizontal plane H or the vertical plane V, and to automatically control the rotation actuator of the tool 120, 210, 220, 230 and/or the tilt actuator 115 to align the rotation angle of the jaw plane P and the tilt angle a₄ at the desired relative orientation 600. In other words, the control unit 105, using for instance the computer implemented pose model 500, can determine the current orientation of the jaw plane P and compare this current orientation to a desired orientation, which may be an orientation that has been input by an operator via the remote control device 190. The desired orientation may for instance be the horizontal plane H, the vertical plane V, or some other plane, such as a 45 degree angle plane relative to the horizontal plane H. The jaw plane P is then maintained in this orientation, regardless of how the operator maneuvers the different movable members on the equipment 100. This function is particularly handy if the work objects, such as the pipes or the rebars at a work site, mainly extends in the desired plane. It is often the case that pipes and other work objects to be demolished by a demolition robot extends horizontally or vertically. FIG. 6A illustrates a current example orientation between a jaw plane P and a reference system 610 comprising the vertical plane V and the horizontal plane H. The orientation of the jaw plane P in relation to the reference system 610 is determined by the angles 620, 630 between a normal to the jaw plane P and the reference system planes.

FIG. 6B instead illustrates a pointing direction 660 of the tool in a reference coordinate system 650. The reference coordinate system 650 comprises a reference plane, in this case the horizontal plane H. A reference direction 670 extends in the reference plane, indicated in FIG. 6B by a dashed line. Any pointing direction 660 can now be indicated by an angle or bearing 680 in the reference plane and an elevation angle relative to the reference plane, as shown in FIG. 6B. The control unit 105 is, according to some aspects, configured to obtain a desired relative pointing direction 660 of the extension axis T of the tool, e.g., from an operator via the remote control device, or automatically in relation to some work object having a detected extension direction. The control unit 105 can also be configured to control the tilt actuator 115 and/or the rotation actuator 430 to reduce a difference between the current pointing direction of the extension axis T of the tool and the desired relative pointing direction of the extension axis T of the tool. The reference system 650 used to define the pointing direction 660 can be based on the support plane of the tracks 150 or the outriggers 145 in combination with the forward direction of the equipment.

The operator 180 controlling the tool 120 may want to rotate the tool by a substantial amount in some cases, and by a smaller amount with more accuracy in some other cases. Normally the operator may wany to quickly rotate the tool 120 to come within range of the desired angle of rotation, and then perform a more fine-grained control of the rotation to fine-tune the orientation of the tool before engaging a work object. To facilitate a more quick rotation of the tool 120, the control unit 105 can be configured to control the rotation actuator 430 to rotate the tool about the extension axis T in discrete rotation steps, where each rotation step comprises rotation by a predetermined or configurable number of degrees. This way the operator can, for instance, configure the tool to rotate in steps of five or ten degrees, and then quickly control say a 60 degree rotation by transmitting the corresponding rotation step commands. A more fine-grained rotation control can then be applied once the tool has been rotated to approximately the desired angle of rotation. The control unit 105 may, advantageously, be configurable in a continuous rotation mode and a discrete step rotation mode which can be selected by the operator 180 using the remote control device 190, or selected in some other way. The control unit 105 can in this case optionally be configured to control the rotation actuator 430 to rotate continuously in response to a control command from the remote control device 190 when in the continuous rotation mode, and to control the rotation actuator 430 to rotate in discrete rotation steps when in the discrete step rotation mode. Rotation in the discrete step rotation mode preferably has a faster angular rate of rotation in terms of radians per second compared to the continuous rotation mode which is more often used for fine-tuning of the tool rotation angle.

Many work objects are elongated and extend in the same direction over a distance, such as a pipe, a wall segment, or a rebar structure, which extends in a straight line over a distance. The operator may desire to engage the same work object at regular intervals, for instance by cutting the pipe into segments of a given length, or demolishing a wall at regular intervals. Aspects of the present disclosure relate to an automated feed function which can be triggered by the operator 180 using the remote control device 190 or in some other way. According to such aspects, the control unit 105 is arranged to obtain a desired feed direction of the tool 120, 210, 220, 230 and to control any of the caterpillar tracks 150, the tower 130, the tool arm 110 and/or the rotation actuator 430 to move the tool along the feed direction in response to a control command from the remote control device 190. The operator 180 can then engage the work object at regular intervals in a convenient, semi-automated manner. The control unit 105 can for instance be arranged to obtain the desired feed direction of the tool 120, 210, 220, 230 as a straight line fit to two or more past positions of the tool. The operator then positions the tool at two or more places along the desired feed direction, and the control unit then determines the desired feed direction by fitting a straight line to the two or more points. A least-squares fit of a line may, e.g., be used to find the desired feed direction from the two or more past positions of the too. The control unit 105 can of course also be arranged to obtain the desired feed direction of the tool 120, 210, 220, 230 from an operator of the equipment via the remote control device 190. This input may be obtained via the display device 330 of the remote control device 190, or in some other way. The feed direction may be provided in a reference system such as the reference system 650 illustrated in FIG. 6B. The operator is then asked to provide a bearing angle and an elevation angle of the desired feed direction of the tool, whereupon the control unit controls the tool to move along the feed direction. A computer implemented model of pose 500, such as the model 500 in FIG. 5, can be used to control the different movable members on the equipment to move along the desired feed direction.

It may also be convenient for the operator to mark desired places on a work object where it is desired to engage the work object. Such as locations on a pipe to be cut into segments, or the positions on a rebar structure where the rebar is to be cut. The operator or other person at the work site can, for instance, use colored spray paint or some other type of visual marker to identify the locations on the work object. The control unit 105, using input from one or more environment sensors 170 on the equipment, can then perform an automated or a semi-automated function to engage the work object at the marked locations. Thus, according to some aspects the remote controlled construction equipment 100 comprises a vision-based sensor arranged to monitor an area in front of the tool 120, 210, 220, 230. The control unit 105 can then be configured to detect a marker arranged on a work object having predetermined visual characteristics, and to control any of the caterpillar tracks 150, the tower 130, the tool arm 110 and/or the rotation actuator 430 to engage the work object at the marker. This is an example of an automated guidance function which the control unit 105 can execute based on data received from one or more environment sensors 170 on the construction equipment 100. More generally, aspects of the present disclosure relate to remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, a tool arm 110 supported on the tower 130, and an environment sensor 170 configured to observe a work object 410 in vicinity of the construction equipment 100. A tool 120, 210, 220, 230 such as steel shears, a concrete crusher, or a grapple tool comprising opposing jaw members 122 arranged movable 121 in a jaw plane P relative to each other is attachable at a distal end of the tool arm 110. The opposing jaw members 122 of the tool 120, 210, 220, 230 are rotatable 125 about an extension axis T of the tool. The control unit 105 is configured to receive data related to an extension direction E of the work object 410 from the environment sensor 170, and to trigger an automated guidance function involving rotation 125 of the tool 120, 210, 220, 230 about the extension axis T to position the opposing jaw members 122 in relation to the work object 410.

The control unit 105 may for instance be arranged to control a rotation actuator 430 of the tool 120 to rotate the tool 120 to a position suitable for engaging the work object 410. The current rotation angle of the tool relative to some reference rotation angle may, e.g., be obtained from a rotary encoder, such as a Hall sensor or the like. The control unit 105 may be configured to receive a signal from the rotary encoder arranged in connection to the tool 120 and thus discern the current rotation angle of the tool relative to the tool arm 110. The control unit 105 can then determine the rotation necessary to align the tool with the work object, such that the extension direction E of the work object 410 is at least approximately normal to the extension jaw plane P of the jaw members. Here, “approximately normal” may be taken to mean at most a 20 degree angle between the extension direction of the work object and the extension plane of the opposing jaw members.

The control unit 105 may also be arranged to obtain data related to a distance 420 between the tool 120, 210, 220, 230 and the work object 410, and to trigger the automated guidance function when the distance 420 satisfies a rotation proximity acceptance criterion. The distance to the work object 410 can be determined by the environment sensor 170 using techniques known in the art, such as using a stereo vision system, a radar sensor, or a lidar sensor which is arranged to measure the distance from the tool 120 to the work object 410. This function will result in a snap-in type of behavior, where the tool is automatically rotated into position to engage the work object as soon as it is moved sufficiently close to the work object. Here, “sufficiently close” may be taken to mean at a distance smaller than 1 m, such as a distance less than 50 cm or so. The automated guidance function may also be automatically triggered by the control unit 105 as soon as a work object has been identified by the environment sensor, i.e., as soon as the extension direction of the work object becomes known at the control unit 105. Note, however, that the rotation angle of the tool and/or tilt angle of the tool which brings the extension direction of the work object into alignment with a normal direction of the jaw plane P is likely to change as the tool arm 110 and the rotation of the tower 130 is manipulated. Thus, the tool rotation and/or the tilt angle of the tool will need to be updated by the control unit 105 as the tool arm is moved around in relation to the work object. At least some of the automated guidance functions described herein comprise a continuous updating of tool rotation and/or tool tilt in response to movement by one or more other movable members on the construction equipment 100.

The automated guidance function preferably also comprises an automated reduction of a movement speed of the tool 120, 210, 220, 230 when the distance 420 satisfies a speed reduction acceptance criterion, such as a predetermined distance threshold. The movement speed of the tool comprises a translational speed determined by the hydraulic flow to the tower rotation actuator, the tool arm actuator cylinders, and the tilt actuator. The control unit 105 may apply a scaling factor to the control input given by the operator in order to reduce the movement speed of the tool. The speed reduction may be gradual, such that the movement speed of the tool for a given control input magnitude decreases with decreasing distance between work object and tool. This reduction in movement speed of the tool results in a more fine grained control of the position of the tool, which helps in positioning the tool correctly in relation to the work object, prior to engagement between the tool and the work object.

The automated guidance function may also comprise an automated positioning and/or alignment of the tool 120, 210, 220, 230 in relation to the work object 410 when the distance 420 satisfies a positioning acceptance criterion. Thus, when the tool 120 comes close enough to the work object 410, such as within 1 m of the work object or so, the control unit 105 will take over, or request to take over control of tool maneuver to position the tool correctly to engage the work object. This automated guidance function is also similar to a snap-in type of function, where the control unit 105 “snaps” the tool into place as soon as the tool is brough sufficiently close to the work object, as determined, e.g., by the environment sensor 170.

According to some aspects, the control unit 105 is furthermore arranged to detect when the opposing jaw members 122 of the tool 120, 210, 220, 230 are correctly positioned for engaging the work object 410, and to trigger an automated actuation of the jaw members 122 as a result of detecting that the jaw members 122 are correctly positioned. This detection of work object position in relation to the gap between the opposing jaw members 122 can be made based on data obtained from the environment sensor 170, and/or using a proximity sensor on the tool, such as a pressure switch. This detection of work object position in relation to the gap between the opposing jaw members 122 can also be based at least in part on monitoring hydraulic pressure in the different hydraulic actuators of the tool arm 110. At least some of these pressure is likely to rise when the tool is pressed up against when work object, with the work object received in the gap between the opposing jaw members. Consequently, according to some aspects, the control unit 105 is arranged to obtain data indicative of a position of the work object 410 relative to the opposing jaw members from the environment sensor 170, and to detect when the opposing jaw members 122 of the tool 120, 210, 220, 230 are correctly positioned when the position of the work object 410 relative to the opposing jaw members satisfies a first jaw engagement acceptance criterion. Additionally, or alternatively, the control unit 105 can also be arranged to obtain data indicative of a hydraulic pressure in one or more hydraulic actuators of the tool arm 110, and to detect when the opposing jaw members 122 of the tool 120, 210, 220, 230 are correctly positioned when the hydraulic pressure satisfies a second jaw engagement acceptance criterion.

The control unit 105 can also be arranged to trigger an automated disengagement routine following engagement between the jaws 122 of the tool 120, 210, 220, 230 and the work object 410. This disengagement routine comprises moving the opposing jaws 122 away from each other followed by moving the tool 120, 210, 220, 230 away from the work object 410. The disengagement routine provides an additional level of automation, which spares the operator 180 some work in controlling the tool to disengage from the work object after, e.g., a pipe or the like has been cut.

FIG. 6 shows an example 700 of an automated work object engagement and disengagement procedure. At time T0 the operator provides an input command 710 to the control unit 105 via the remote control device 190 comprising an instruction to perform an automated cutting, crushing, or grasping procedure. Note that the operator continuously provides the input command 710 during the entire procedure, for safety reasons. The control unit 105 initially performs an alignment procedure 720 comprising an automated rotation of the tool about the extension axis T in order to place the opposing jaw members in position to engage an identified work object. A tilting of the tool 120 may also be performed as part of the alignment procedure 720. The control unit 105, having ascertained that the work object is correctly positioned between the opposing jaw members of the tool 120, then actuates the jaw members 730 at time T1 by moving them towards each other starting from an open state where the jaw members are distanced from each other. Once the jaw members have been closed, the control unit 105 opens up the jaw members again 740, at time T2, and then moves the tool 120 away from the work object 750, starting at time T3. The operation is concluded at time T4 when the operator ceases to provide the input command 510.

For safety reasons, the control unit 105 may be configured to abort execution of any automated guidance function in case the operator 180 releases the remote control device 190 and/or discontinues manipulation of the remote control device 190. Thus, should the operator have prematurely discontinued input of the command 710 in the example 700, the automated guidance procedure would have been aborted, and any tool movement would have been terminated.

Referring back to FIG. 3, the remote control device 190 or some other part of the construction equipment 100 or remote control station may comprise a display device 330 arranged to display an image of a potential work object 410, such as an image captured by a camera, or a point cloud image from a radar or a lidar sensor. The control unit 105 can then be arranged to obtain confirmation from an operator 180, via the display device or via some other input device, indicating that the potential work object is a work object to be engaged by the tool. In other words, an image of what lies in front of the tool can be displayed to the operator with an indication of a potential work object, and a request for confirmation that the work object is indeed a work object to be engaged by the tool, and not some other object, can be obtained from the operator. The automated guidance function then proceeds only if the operator first confirms that the object in front of the tool is, in fact, a work object to be engaged by the tool, and not some other object. This function increases safety of the construction equipment 100. Similarly, the control unit 105 can also be arranged to obtain input from an operator 180 of the construction equipment 100 indicating a work object 410 to be engaged by the tool. In this case the operator can indicate which object, if any, is in the displayed image that constitutes a work object to be engaged by the tool. The operator input can be obtained using a touch screen, or some other input device, like one of the joysticks 310, 320.

It is appreciated that the operator may be assisted by an automated alignment of the tool 120 with respect to some global reference plane instead of in relation to some work object detected by an environment sensor. This function also avoids the need for an environment sensor, which may be an advantage in some cases. Consequently, there is disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, and a tool arm 110 supported on the tower 130, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool, and where the control unit 105 is configured to obtain a horizontal and/or a vertical alignment command from the remote control device 190, and to automatically control a rotation actuator of the tool 120, 210, 220, 230 to align the jaw plane P with a horizontal and/or a vertical direction, respectively.

There is also disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, and a tool arm 110 supported on the tower 130, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool by a rotation actuator, where the tool 120, 210, 220, 230 is tiltable about a pivot axis 114 by a tilt actuator 115, and where the control unit 105 is configured to obtain a desired angle between the jaw plane P and a reference plane, and to automatically control the rotation actuator of the tool and/or the tilt actuator 115 of the tool to align the jaw plane P at the desired angle relative to the reference plane.

FIG. 8A is a flow chart illustrating a computer-implemented method, executed by a control unit 105 arranged on construction equipment 100 configured to receive control commands from a remote control device 190. The construction equipment 100 comprises a tool arm 110 rotatably supported on a tower 130, where a tool 120, 210, 220, 230 comprising opposing jaw members 122 arranged movable 121 in a jaw plane P relative to each other is attachable at a distal end of the tool arm 110, and where the opposing jaw members 122 of the tool 120, 210, 220, 230 are rotatable 125 about an extension axis T of the tool by a rotation actuator 430. The tool 120, 210, 220, 230 comprises a rotary encoder, as discussed above, i.e., an encoder that is configured to determine a current rotation angle of the jaw plane P relative to the tool arm 110, and to send a signal indicative of the current rotation angle to the control unit 105. The method comprises obtaining S1a the signal indicative of the current rotation angle of the tool from the rotary encoder, obtaining S2a a signal from the remote control device 190 indicative of a desired tool rotation angle of the tool, and controlling S3a the rotation actuator 430 to reduce a difference between the current rotation angle and the desired rotation angle of the tool.

FIG. 8B is a flow chart illustrating a computer-implemented method, performed by a control unit 105 on a remote controlled construction equipment 100, the construction equipment 100 comprising an environment sensor 170 configured to observe a work object 410 in vicinity of the construction equipment 100, and a tool 120, 210, 220, 230 with opposing jaw members 122 arranged movable 121 in a jaw plane P relative to each other, where the opposing jaw members 122 of the tool 120, 210, 220, 230 are rotatable 125 about an extension axis T of the tool in response to a rotation control signal. The method comprises:
receiving S1b a command from a remote control device 190 of the construction equipment 100 related to the work object 410,
receiving S2b data related to an extension direction E of the work object 410 from the environment sensor 170, and
triggering S3b an automated guidance function involving rotation 125 of the tool 120, 210, 220, 230 about the extension axis T to position the opposing jaw members 122 in relation to the work object 410.

FIG. 9 schematically illustrates, in terms of a number of functional units, the general components of a control unit 900. This control unit can be used to implement, e.g., parts of the control unit 105 onboard the construction equipment 100 or the remote control device control unit 300. Processing circuitry 910 is provided using any combination of one or more of a suitable central processing unit CPU, multiprocessor, microcontroller, digital signal processor DSP, etc., capable of executing software instructions stored in a computer program product, e.g., in the form of a storage medium 830. The processing circuitry 910 may further be provided as at least one application specific integrated circuit ASIC, or field programmable gate array FPGA.

Particularly, the processing circuitry 910 is configured to cause the device 900 to perform a set of operations, or steps, such as the methods discussed in connection to FIG. 4 and the discussions above. For example, the storage medium 830 may store the set of operations, and the processing circuitry 910 may be configured to retrieve the set of operations from the storage medium 830 to cause the device to perform the set of operations. The set of operations may be provided as a set of executable instructions. Thus, the processing circuitry 910 is thereby arranged to execute methods as herein disclosed.

The storage medium 830 may also comprise persistent storage, which, for example, can be any single one or combination of magnetic memory, optical memory, solid state memory or even remotely mounted memory.

The device 105, 300, 900 may further comprise an interface 920 for communications with at least one external device. As such the interface 920 may comprise one or more transmitters and receivers, comprising analogue and digital components and a suitable number of ports for wireline or wireless communication.

The processing circuitry 910 controls the general operation of the control unit 900, e.g., by sending data and control signals to the interface 920 and the storage medium 830, by receiving data and reports from the interface 920, and by retrieving data and instructions from the storage medium 830.

FIG. 10 illustrates a computer readable medium 1010 carrying a computer program comprising program code means 1020 for performing the methods illustrated in FIG. 6, when said program product is run on a computer. The computer readable medium and the code means may together form a computer program product 1000.

The following embodiments are illustrative only and do not limit the scope of the invention as defined by the claims. Any feature described in one embodiment may be combined with one or more features of any other embodiment, unless clearly stated otherwise.

There is disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, and a tool arm 110 supported on the tower 130, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool by a rotation actuator 430, where the control unit 105 is configured to obtain a desired relative orientation 600 between the jaw plane P and a reference plane 610, H, V, and to automatically control the rotation actuator of the tool 120, 210, 220, 230 and/or a tilt actuator 115 to align the rotation angle of the jaw plane P and the tilt angle a₄ at the desired relative orientation 600.

There is disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, and a tool arm 110 supported on the tower 130, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool by a rotation actuator 430, where the control unit 105 is configured to control the rotation actuator 430 to rotate the tool about the extension axis T in discrete rotation steps, where each rotation step comprises rotation by a predetermined or configurable number of degrees.

There is disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, and a tool arm 110 supported on the tower 130, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool by a rotation actuator 430, where the control unit 105 is arranged to obtain a desired feed direction of the tool 120, 210, 220, 230, where the control unit 105 is configured to control any of the caterpillar tracks 150, the tower 130, the tool arm 110 and/or the rotation actuator 430 to move the tool along the feed direction in response to a control command from the remote control device 190.

There is disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, a tool arm 110 supported on the tower 130, and a vision-based sensor arranged to monitor an area in front of the tool 120, 210, 220, 230, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool by a rotation actuator 430, where the control unit 105 is configured to detect a marker arranged on a work object having predetermined visual characteristics, and to control any of the caterpillar tracks 150, the tower 130, the tool arm 110 and/or the rotation actuator 430 to engage the work object at the marker.

There is disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, and a tool arm 110 supported on the tower 130, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool, where the control unit 105 is configured to obtain a horizontal and/or a vertical alignment command from the remote control device 190, and to automatically control a rotation actuator of the tool 120, 210, 220, 230 to align the jaw plane P with a horizontal and/or a vertical direction, respectively.

There is disclosed remote controlled construction equipment 100 comprising a control unit 105 configured to receive control commands from a remote control device 190, a chassis 140 with caterpillar tracks 150 arranged to support the equipment 100 on a ground surface 101, a tower 130 rotatably supported on the chassis 140 to rotate about an axis of rotation R, a tool arm 110 supported on the tower 130, and an environment sensor 170 configured to observe a work object 410 in vicinity of the construction equipment 100, where a tool 120, 210, 220, 230 comprising opposing jaw members 122 arranged movable 121 in a jaw plane P relative to each other is attachable at a distal end of the tool arm 110, where the opposing jaw members 122 of the tool 120, 210, 220, 230 are rotatable 125 about an extension axis T of the tool, where the control unit 105 is configured to receive data related to an extension direction E of the work object 410 from the environment sensor 170, and to trigger an automated guidance function involving rotation 125 of the tool 120, 210, 220, 230 about the extension axis T to position the opposing jaw members 122 in relation to the work object 410.

1. Remote controlled construction equipment comprising a control unit configured to receive control commands from a remote control device, a chassis with caterpillar tracks arranged to support the equipment on a ground surface, a tower rotatably supported on the chassis to rotate about an axis of rotation, and a tool arm supported on the tower,
wherein a tool comprising opposing jaw members arranged movable in a jaw plane relative to each other is attachable at a distal end of the tool arm,
wherein the opposing jaw members of the tool are rotatable about an extension axis of the tool by a rotation actuator, and
wherein the tool and/or the distal end of the tool arm comprises a rotary encoder configured to determine a current rotation angle of the jaw plane relative to the tool arm, and to send a signal indicative of the current rotation angle to the control unit.

2. The construction equipment according to claim 1,
wherein the tool is tiltable about a pivot axis at the distal end of the tool arm by a tilt actuator,
wherein the control unit is arranged to determine a current tilt angle of the tool based on a state of the tilt actuator, and
wherein the control unit is configured to obtain a desired relative orientation between the jaw plane and a reference plane, and to automatically control the rotation actuator of the tool and/or the tilt actuator to align the rotation angle of the jaw plane and the tilt angle at the desired relative orientation.

3. The construction equipment according to claim 2, wherein the control unit is configured to obtain a desired relative pointing direction of the extension axis of the tool,
wherein the control unit is configured to control the tilt actuator and the rotation actuator to reduce a difference between a current pointing direction of the extension axis of the tool and the desired relative pointing direction of the extension axis of the tool.

4. The construction equipment according to claim 1, wherein the control unit is configured to control the rotation actuator to rotate the tool about the extension axis in discrete rotation steps, wherein each rotation step comprises rotation by a predetermined or configurable number of degrees.

5. The construction equipment according to claim 1,
wherein the control unit is configurable in a continuous rotation mode and a discrete step rotation mode,
wherein the control unit is configured to control the rotation actuator to rotate continuously in response to a control command from the remote control device when in the continuous rotation mode,
wherein the control unit is configured to control the rotation actuator to rotate in discrete rotation steps when in the discrete step rotation mode.

6. The construction equipment according to claim 5, wherein rotation in the discrete step rotation mode has a faster angular rate of rotation compared to the continuous rotation mode.

7. The construction equipment according to claim 1, wherein the control unit is arranged to obtain a desired feed direction of the tool,
wherein the control unit is configured to control any of the caterpillar tracks, the tower, the tool arm and/or the rotation actuator to move the tool along the feed direction in response to a control command from the remote control device.

8. The construction equipment according to claim 7, wherein the control unit is arranged to obtain the desired feed direction of the tool
as a straight line fit to two or more past positions of the tool, or from an operator of the equipment via the remote control device.

9. The construction equipment according to claim 1, comprising a vision-based sensor arranged to monitor an area in front of the tool, wherein the control unit is configured to detect a marker arranged on a work object having predetermined visual characteristics, and to control any of the caterpillar tracks, the tower, the tool arm and/or the rotation actuator to engage the work object at the marker.

10. The construction equipment according to claim 1,
comprising an environment sensor configured to observe a work object in vicinity of the construction equipment,
wherein the control unit is configured to receive data related to an extension direction (E) of the work object from the environment sensor, and to trigger an automated guidance function involving rotation of the tool about the extension axis to position the opposing jaw members in relation to the work object.

11. The construction equipment according to claim 10, wherein the control unit is arranged to control the rotation actuator of the tool to rotate the tool to a position suitable for engaging the work object, or
wherein the control unit is arranged to obtain data related to a distance between the tool and the work object, and to trigger the automated guidance function when the distance satisfies a rotation proximity acceptance criterion.

12. The construction equipment according to claim 10, wherein the automated guidance function comprises:
an automated reduction of a movement speed of the tool when the distance satisfies a speed reduction acceptance criterion, or an automated positioning and/or alignment of the tool in relation to the work object when the distance satisfies a positioning acceptance criterion.

13. The construction equipment according to claim 10, wherein the control unit is arranged to detect when the opposing jaw members of the tool are correctly positioned for engaging the work object, and to trigger an automated actuation of the jaw members as a result of detecting that the jaw members are correctly positioned.

14. The construction equipment according to claim 13, wherein the control unit is arranged to obtain data indicative of a position of the work object relative to the opposing jaw members from the environment sensor, and to detect when the opposing jaw members of the tool are correctly positioned when the position of the work object relative to the opposing jaw members satisfies a first jaw engagement acceptance criterion,
wherein the control unit is arranged to obtain data indicative of a hydraulic pressure in one or more hydraulic actuators of the tool arm, and to detect when the opposing jaw members of the tool are correctly positioned when the hydraulic pressure satisfies a second jaw engagement acceptance criterion, or wherein the control unit is configured to abort the automated guidance function in case the operator releases the remote control device and/or discontinues manipulation of the remote control device.

15. The construction equipment according to claim 1, wherein the control unit is arranged to trigger an automated disengagement routine following engagement between the jaws of the tool and the work object, the disengagement routine comprising moving the opposing jaws away from each other followed by moving the tool away from the work object.

16. The construction equipment according to claim 1, comprising a display device arranged to display:
an image of a potential work object, wherein the control unit is arranged to obtain confirmation from an operator indicating that the potential work object is a work object to be engaged by the tool, or an image of a surrounding environment of the construction equipment, wherein the control unit is arranged to obtain input from an operator of the construction equipment indicating a work object to be engaged by the tool.

17. The construction equipment according to claim 1, wherein the control unit is configured to obtain a horizontal and/or a vertical alignment command from the remote control device, and to automatically control the rotation actuator of the tool to align the jaw plane with a horizontal and/or a vertical direction, respectively.

18. A computer-implemented method, executed by a control unit arranged on construction equipment configured to receive control commands from a remote control device, the construction equipment comprising a tool arm rotatably supported on a tower,
wherein a tool comprising opposing jaw members arranged movable in a jaw plane relative to each other is attachable at a distal end of the tool arm,
wherein the opposing jaw members of the tool are rotatable about an extension axis of the tool by a rotation actuator,
wherein the tool comprises a rotary encoder configured to determine a current rotation angle of the jaw plane relative to the tool arm, and to send a signal indicative of the current rotation angle to the control unit,
the method comprising obtaining the signal indicative of the current rotation angle of the tool from the rotary encoder,
obtaining a signal from the remote control device indicative of a desired tool rotation angle of the tool, and
controlling the rotation actuator to reduce a difference between the current rotation angle and the desired rotation angle of the tool.

19. A computer-implemented method, executed by a control unit on a remote controlled construction equipment configured to receive control commands from a remote control device, the construction equipment comprising a tool arm rotatably supported on a tower,
wherein a tool comprising opposing jaw members arranged movable in a jaw plane relative to each other is attachable at a distal end of the tool arm,
wherein the opposing jaw members of the tool are rotatable about an extension axis of the tool by a rotation actuator,
wherein the tool comprises a rotary encoder configured to determine a current rotation angle of the jaw plane relative to the tool arm, and to send a signal indicative of the current rotation angle to the control unit,
the construction equipment comprising an environment sensor configured to observe a work object in vicinity of the construction equipment,
the method comprising:
receiving a command from the remote control device of the construction equipment related to the work object,
receiving data related to an extension direction of the work object from the environment sensor, and
triggering an automated guidance function involving rotation of the tool about the extension axis, by the rotary encoder, to position the opposing jaw members in relation to the work object.

20. A computer program product comprising program code for performing, when executed by a control unit comprising processing circuitry, the method of claim 19.
